(19) United States
(12) Patent Application Publication
(10) Pub. No.: US 2017/0359575 A1
(43) Pub. Date: Dec. 14, 2017

(54) Non-Uniform Digital Image Fidelity and Video Coding

(71) Applicant: Apple Inc., Cupertino, CA (US)

(72) Inventors: Dazhong Zhang, Milpitas, CA (US); Hang Yuan, San Jose, CA (US); Peikang Song, San Jose, CA (US); Jae Hoon Kim, San Jose, CA (US); Xing Wen, Cupertino, CA (US); Sudeng Hu, San Jose, CA (US); Xiaosong Zhou, Campbell, CA (US); Chris Chung, Sunnyvale, CA (US); Hsi-Jung Wu, San Jose, CA (US)

(21) Appl. No.: 15/613,885

(22) Filed: Jun. 5, 2017

Related U.S. Application Data
(60) Provisional application No. 62/347,915, filed on Jun. 9, 2016.

(51) Int. Cl. H04N 19/103; H04N 19/176; H04N 19/11; H04N 19/186; H04N 19/61; H04N 19/50; G06T 9/00; H04N 19/136; H04N 19/196

(52) U.S. Cl. CPC H04N 19/103; H04N 19/136; H04N 19/176; H04N 19/11; H04N 19/196; H04N 19/61; H04N 19/50; G06T 9/001; H04N 19/186

(57) ABSTRACT

A video coder defines multiple fidelity regions in different spatial areas of a video sequence, each of which may have different fidelity characteristics. The coder may code the different representations in a common video sequence. Where prediction data crosses boundaries between the regions, interpolation may be performed to create like kind representations between prediction data and video content being coded.

### CROSS REFERENCE TO RELATED APPLICATIONS

This application benefits from priority of application Ser. No. 62/347,915, filed Jun. 9, 2016 and entitled “Non-Uniform Digital Image Fidelity and Video Coding,” the disclosure of which is incorporated herein by its entirety.

### BACKGROUND

Current digital image and video coding systems typically process video data with uniform fidelity (meaning the sampled pixels are equally spaced) with the same color format, bit-depth, color gamut, etc. However there are situations where non-uniform fidelity is preferred.

Although scalable video coding system could be used to support coding of video data with non-uniform fidelity by coding different portions of video data with different fidelity characteristics in different enhancement layers, such techniques would have a number of drawbacks.

For example, more layers means more overhead and use of multiple layers to carry image data of different fidelities would result in higher-bit-rate coding, even if coding data were forced to skip mode in areas that did not carry data of relevant fidelity. Further, encoding/decoding entire frames at multiple layers requires more memory and processing cycles. As other example drawbacks, modern scalable video coding standards do not support color format scalability and boundaries between image areas having different fidelities would have to be aligned to coding blocks of the different layers. In addition, quality disruption would occur at boundaries between image areas having different fidelities, which may cause unpleasant visual effects with low number of enhancement layers.

Accordingly, the inventors perceive a need in the art for a coding system that codes images with non-uniform fidelity regions by single layer coding.

### BRIEF DESCRIPTION OF THE DRAWINGS

FIG. 1 is a simplified block diagram of a video coding system 100 according to an embodiment of the present disclosure.

FIG. 2 is a simplified block diagram of a video decoding system 200 according to an embodiment of the present disclosure.

FIG. 3 illustrates a communication flow 300 between encoders and decoders according to an embodiment of the present disclosure.

FIG. 4 illustrates an example frame according to an embodiment of the present disclosure.

FIG. 5 illustrates an example pixel block according to an embodiment of the present disclosure.

FIG. 6 illustrates an example computer system according to an embodiment of the present disclosure.

### DETAILED DESCRIPTION

Embodiments of the present disclosure provide techniques for non-uniform digital image fidelity and video coding. According to these techniques, a plurality of fidelity regions within an image may be identified. Each fidelity region may be associated with a fidelity characteristic. Video encoding may be performed for each pixel block of the image. The video encoding for each pixel block may include determining whether image data of a fidelity region neighboring the pixel block's fidelity region is a candidate for prediction. If so, content of the neighboring fidelity region may be interpolated using the fidelity characteristic of the pixel block. Subsequently, the pixel block may be predictively encoded using interpolated content.

As an example, a video coder may define multiple fidelity regions in different spatial areas of a video sequence, each of which may have different fidelity characteristics. The coder may code the different representations in a common video sequence. Where prediction data crosses boundaries between the regions, interpolation may be performed to create like kind representations between prediction data and video content being coded.

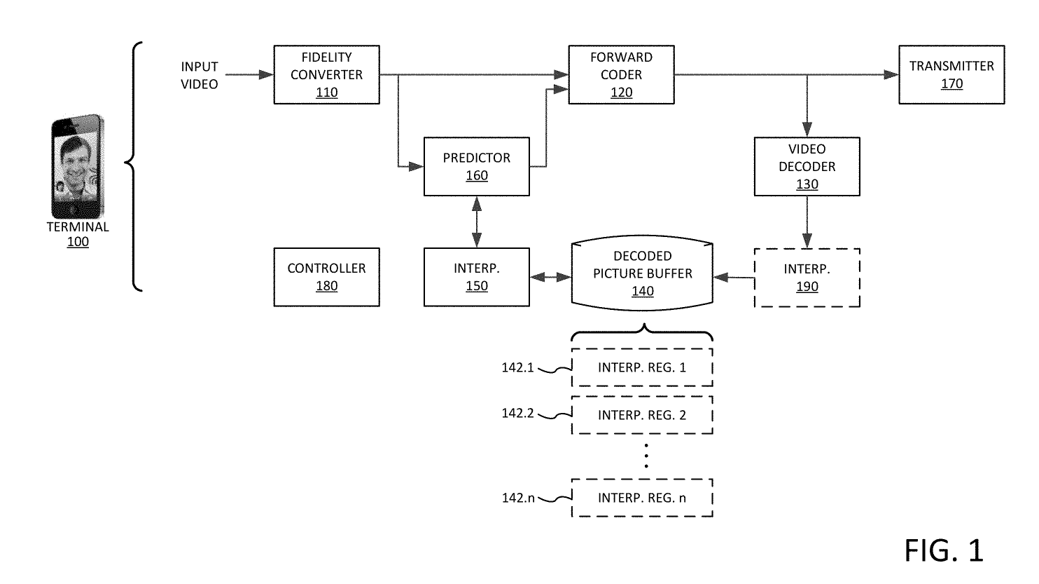

FIG. 1 is a simplified block diagram of a video coding system 100 according to an embodiment of the present disclosure. The coding system 100 may include a fidelity converter 110, a forward coder 120, a video decoder 130, a decoded picture buffer 140, an interpolator 150, a predictor 160, a transmitter 170, and a controller 180. The fidelity converter 110 may parse an input image into regions and convert the respective regions according to the fidelity characteristics defined for the regions. The forward coder 120 may perform forward coding of pixel blocks according to the predictive coding techniques. The video decoder 130 may invert the forward coding processes applied to select coded frames to generate “reference frames,” which may be used to as a basis to code latter-received frames from input video. The decoded picture buffer 140 may store decoded data of the reference pictures. The interpolator 150 may perform cross-region interpolation. The predictor 160 may predict content of new image data from stored content in the decoded picture buffer 140. The transmitter 170 may transmit coded video data from the forward coder 120 to a channel. The components of the coding system 100 may operate under control of the controller 180.

The fidelity converter 110 may analyze input video and assign different fidelity characteristics to different spatial regions of the input video. The fidelity characteristics of a region may include respective definitions of characteristics that are useful to represent image content of the region such as pixel density, color format, bit-depth or color gamut. Thus, where one region may have a 4:4:4 color format assigned to it, another region may have a 4:2:0 or 4:2:2 format assigned to it. Similarly, one region may utilize 16-bit assignments for color bit depth where another region may have 8- or 10-bit bit depths. Still further, one region may have BT.2020 color gamut to represent image data where another region may utilize BT.709 bit depth.

Fidelity regions may be defined based on content analysis performed across video data (or portion thereof) that prioritizes image content and estimates coding quality that likely is to arise of different fidelity representations. For example, prioritization may be performed based on region of interest (ROI) detection that identifies human faces or other foreground objects from video content. ROI detection also may be performed by foreground/background discrimination processes, or field of focus estimation in virtual/augmented reality (VR/AR), or estimation of objects motion within image data. Another example is screen content coding, in which case higher fidelity may be assigned to areas like text and other graphic rendered objects.

Video frames may be parsed into pixel blocks, which represent spatial arrays of those frames. Pixel blocks need not be located wholly within one region or another so, as a consequence, some blocks may have content that belongs to different fidelity regions. Prediction operations may be performed using interpolation (represented by interpolator 150) that cause prediction operations such as motion prediction searches to convert candidate prediction data stored in the decoded picture buffer 140 to fidelity characteristics of the pixel block being coded.

In an embodiment, decoded video data from the video decoder 130 may be subject to interpolation (represented by interpolator 190) prior to being stored in the decoded picture buffer 140. Such interpolation may generated as a plurality of interpolation regions 142.1-142.n which may be stored in the decoded picture buffer 140.

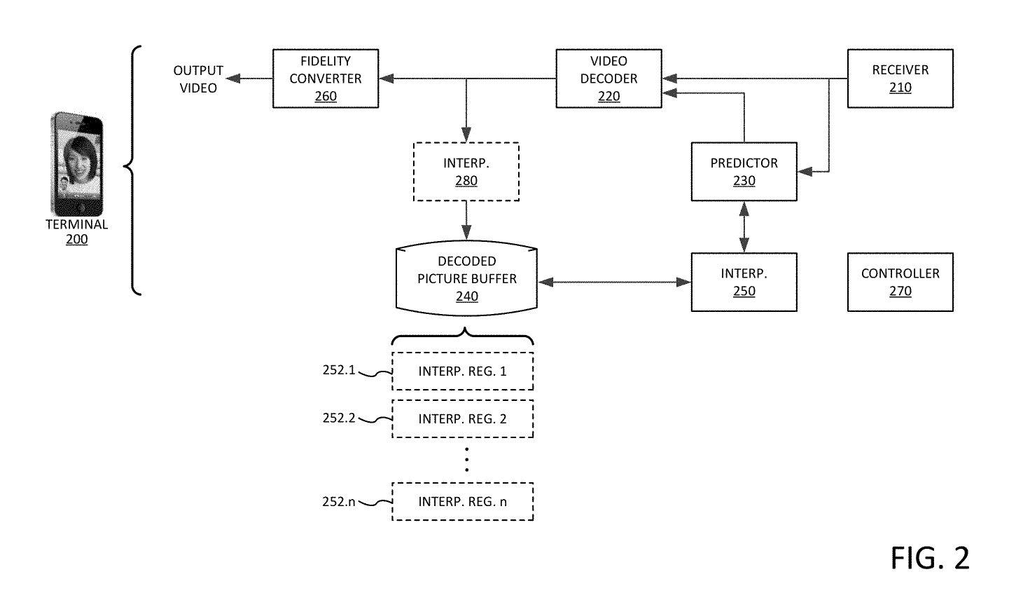

FIG. 2 is a simplified block diagram of a video decoding system 200 according to an embodiment of the present disclosure. The decoding system 200 may include a receiver 210, a video decoder 220, a predictor 230, a decoded picture buffer 240, an interpolator 250, a fidelity converter 260, and a controller 270. The receiver 210 may receive coded video data from a channel and forwards it to the video decoder 220. The video decoder 220 may invert the forward coding processes applied to the coded video data. Recovered video data may be output to the fidelity converter 260. Recovered video data of reference frames may be stored in a decoded picture buffer 240. The predictor 230 may predict content of coded image data from stored content in the decoded picture buffer 240 using prediction references contained in the coded video data. The decoded picture buffer 240 may store decoded data of the reference pictures. The interpolator 250 may perform cross-region interpolation. The fidelity converter 260 may convert image data from their representations in the various fidelity regions to a unified representation suitable for output as output video. The components of the decoding system 200 may operate under control of the controller 270.

Coded video data may be defined using pixel blocks as bases of representation, which represent spatial arrays of corresponding frames. As indicated, pixel blocks need not be located wholly within one region or another so, as a consequence, some blocks may have content that belongs to different fidelity regions. When prediction reference data identifies a portion of a reference frame as a basis of prediction, the interpolator 250 may convert the prediction data stored in the decoded picture buffer 240 to fidelity characteristics of the pixel block being decoded.

In an embodiment, decoded video data from the video decoder 220 may be subject to interpolation (represented by interpolator 290) prior to being stored in the decoded picture buffer 240. Such interpolation may be generated as a plurality of interpolation regions 252.1-252.n which may be stored in the decoded picture buffer 240.

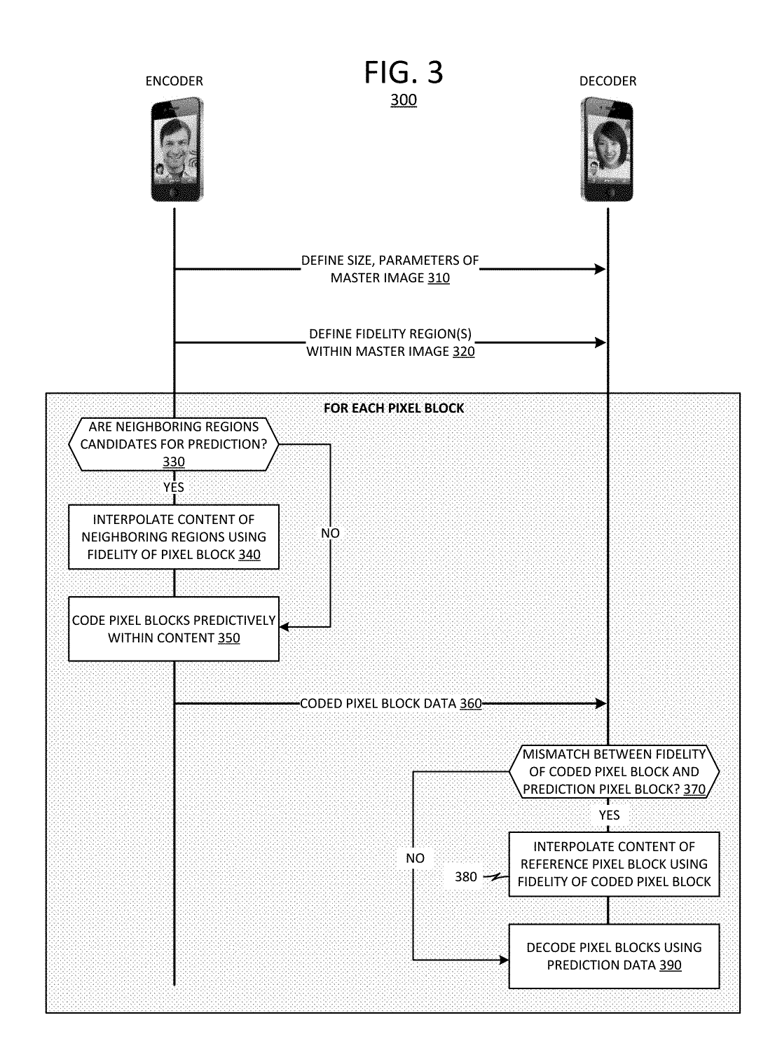

FIG. 3 illustrates a communication flow 300 between encoders and decoders according to an embodiment of the present disclosure. Communication flow 300 may begin with an encoder transmitting a message 310 to a decoder defining size and/or parameters of a “master image.” The master image may define an image space in which regions will be defined. Thereafter, the encoder may transmit message(s) 320 defining fidelity regions within the master image.

With the various fidelity regions thus defined, exchange of coded video may commence. An encoder may code video frames on a pixel block by pixel block basis. For each pixel block, the method 300 may determine whether image data of neighboring regions are candidates for prediction (box 330) and, if so, the encoder may interpolate content of neighboring regions using the fidelity characteristics of the pixel block being coded (box 340). Thereafter, the encoder may code the pixel block predictively (box 350) using either reference frame data that already matches the fidelity characteristics of the pixel block being coded or the interpolated content generated at box 330. The encoder may transmit the coded video data to the decoder (msg. 360).

At the decoder, the decoder may analyze prediction references within the coded pixel block data to determine whether there is a mismatch between fidelity characteristics of reference frame data that will serve as prediction data for the pixel block and fidelity characteristics of the pixel block itself (box 370). If so, the decoder may convert content of the reference pixel block to the fidelity domain of the coded pixel block (box 380). Such conversion, of course, is unnecessary if the prediction data matches the fidelity characteristics of the pixel block being decoded. Thereafter, the decoder may decode the coded pixel block using the prediction data (box 390).

Fidelity regions may be defined in a variety of ways. Where pixel density varies among regions, the positions of pixels in each region may be explicitly described in a binary map, which may be compressed losslessly. The map may identify pixel locations using locations of pixels in the master image as a basis for comparison. The map may be signaled per frame or only when a change happens.

Alternatively, pixel density information may be described as a function of spatial offsets (x, y) with regard to the top left corner of the master image:
Density_x=func(x, y)
Density_y=func(x, y)
   where Density_x and Density_y may represent the horizontal and vertical densities, respectively.

In another embodiment, interval distances between two adjacent sample pixels (Interval_x and Internal_y for example) may be represented, again, in pixel increments of the master image. In addition, an initial re-sampled pixel position may be defined relative to the top-left corner of the original image. Again, this information may be signaled per frame or only when changed.

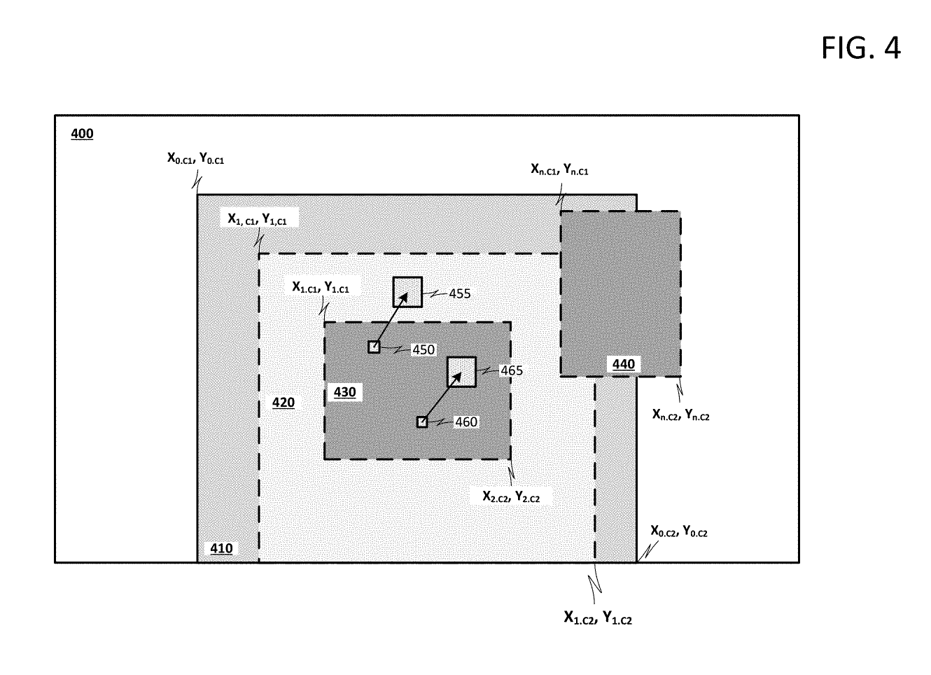

Another way of signaling the density is to partition the frame into multiple tiles or slices with each one covering one density. Different tiles/slices may overlap between each other, as shown in the example of FIG. 4.

In the example of FIG. 4, the locations of each region of a frame 400 are identified by coordinates of diagonally opposite corners, such as <X_{0.C1},Y_{0.C1}> and <X_{0.C2},Y_{0.C2}> for region 410. Other regions 420, 430, 440 may be defined in a similar manner. Other parameters may be provided to define the fidelity characteristics of image data in each region.

As illustrated, the regions 410-440 may overlap each other spatially. Where overlap occurs between regions, the region having highest fidelity (e.g., highest pixel density, highest bit depth, etc.) may be taken to govern in the region of overlap.

As indicated, pixel block boundaries need not align with region boundaries. Accordingly, pixel blocks may contain image data with non-uniform fidelity characteristics. As indicated, interpolation of image content may be performed to develop prediction data that matches the fidelity characteristics of the pixel blocks being coded.

As an example, a pixel block 450 may be identified in the frame 400 and located within the region 430. An area 455 may be identified as a candidate for prediction with respect to the pixel block 450. Notably, the candidate area 455 is found within the region 420 neighboring the region 430. Therefore, the frame 400 may be encoded by interpolating content of the region 420 using the fidelity characteristics of the pixel block 450. The pixel block 450 may be predictively coded using the interpolated content.

Conversely, a pixel block 460 may also be within the region 430. An area 465 may be identified as a prediction candidate with respect to pixel block 460. However, in this case, the candidate area 465 is also within the region 430 with the pixel block 460. Thus, the pixel block 460 may be predictively coded using reference frame data that already matches the fidelity characteristic of the pixel block 460.

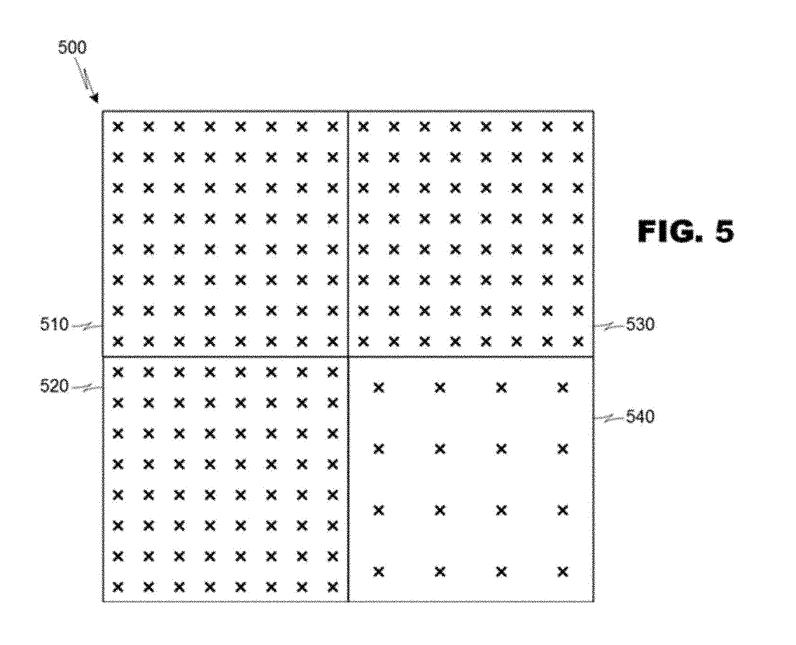

Other processes may be performed for coding pixel blocks. To perform transform coding (for example, conversion from pixel residuals to discrete cosine transform coefficients), a non-uniform residual block either may be padded with additional residual values to create a pixel block with uniform density of coefficients or it may be partitioned into sub-blocks with uniform density of residuals. For example, FIG. 5 illustrates a pixel block 500 having non-uniform pixel density. The pixel block 500 may be partitioned into sub-blocks 510, 520, 530, 540 each of which has uniform pixel density. The sub-blocks may be coded individually, to simplify coding operations.

The foregoing discussion has described operation of the embodiments of the present disclosure in the context of video coders and decoders. Commonly, these components are provided as electronic devices. Video decoders and/or controllers can be embodied in integrated circuits, such as application specific integrated circuits, field programmable gate arrays and/or digital signal processors. Alternatively, they can be embodied in computer programs that execute on camera devices, personal computers, notebook computers, tablet computers, smartphones or computer servers. Such computer programs typically are stored in physical storage media such as electronic-, magnetic- and/or optically-based storage devices, where they are read to a processor and executed. Decoders commonly are packaged in consumer electronics devices, such as smartphones, tablet computers, gaming systems, DVD players, portable media players and the like; and they also can be packaged in consumer software applications such as video games, media players, media editors, and the like. And, of course, these components may be provided as hybrid systems that distribute functionality across dedicated hardware components and programmed general-purpose processors, as desired.

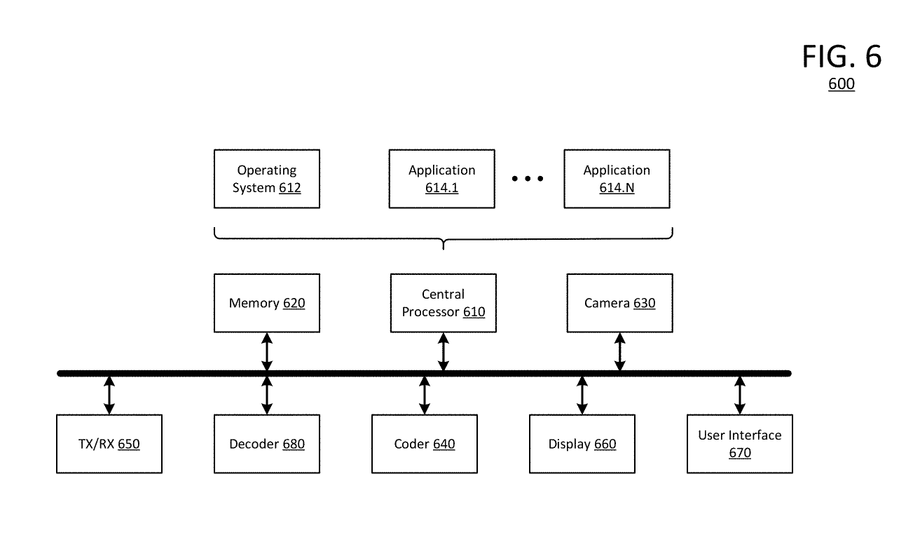

For example, the techniques described herein may be performed by a central processor of a computer system. FIG. 6 illustrates an exemplary computer system 600 that may perform such techniques. The computer system 600 may include a central processor 610 and a memory 620. The central processor 610 may read and execute various program instructions stored in the memory 620 that define an operating system 612 of the system 600 and various applications 614.1-614.N. The program instructions may cause the processor to perform image processing, including encoding and decoding techniques described hereinabove. They also may cause the processor to perform video coding also as described herein. As it executes those program instructions, the central processor 610 may read, from the memory 620, image data representing the multi-view image and may create extracted video that is return to the memory 620.

As indicated, the memory 620 may store program instructions that, when executed, cause the processor to perform the techniques described hereinabove. The memory 620 may store the program instructions on electrical-, magnetic- and/or optically-based storage media.

The system 600 may possess other components as may be consistent with the system's role as an image source device, an image sink device or both. Thus, in a role as an image source device, the system 600 may possess one or more cameras 630 that generate the multi-view video. The system 600 also may possess a coder 640 to perform video coding on the video and a transmitter 650 (shown as TX) to transmit data out from the system 600. The coder 640 may be provided as a hardware device (e.g., a processing circuit separate from the central processor 610) or it may be provided in software as an application 614.1.

In a role as an image sink device, the system 600 may possess a receiver 650 (shown as RX), a decoder 680, a display 660 and user interface elements 670. The receiver 650 may receive data and the decoder 680 may decode the data. The display 660 may be a display device on which content of the view window is rendered. The user interface 670 may include component devices (such as motion sensors, touch screen inputs, keyboard inputs, remote control inputs and/or controller inputs) through which operators input data to the system 600.

Several embodiments of the present disclosure are specifically illustrated and described herein. However, it will be appreciated that modifications and variations of the present disclosure are covered by the above teachings and within the purview of the appended claims without departing from the spirit and intended scope of the disclosure.

We claim:

1. A method comprising:
defining a plurality of fidelity regions within an image, each fidelity region associated with a fidelity characteristic; and
performing video encoding for each pixel block of the image, the video encoding comprising:
determining whether image data of a fidelity region neighboring the pixel block's fidelity region is a candidate for prediction,
if the image data of the neighboring fidelity region is determined to be a candidate for prediction, interpolating content of the neighboring fidelity region using the fidelity characteristic of the fidelity region in which the pixel block is located, and
predictively encoding the pixel block using the interpolated content.

2. The method of claim 1, wherein the encoding further comprises:
if image data of the neighboring fidelity region is not determined to be a candidate for prediction, predictively encoding the pixel block using reference frame data matching the fidelity characteristic of the fidelity region in which the pixel block is located.

3. The method of claim 1, further comprising:
transmitting the encoded image to a decoder.

4. The method of claim 1, wherein the fidelity characteristic is pixel density.

5. The method of claim 1, wherein the fidelity characteristic is color format.

6. The method of claim 1, wherein the fidelity characteristic is bit-depth.

7. The method of claim 1, wherein the fidelity characteristic is color gamut.

8. The method of claim 1, wherein the plurality of fidelity regions are defined according to an identified region-of-interest.

9. The method of claim 1, wherein the plurality of fidelity regions are defined according to screen content coding.

10. A method comprising:
receiving data defining a plurality of fidelity regions within a master image, each fidelity region associated with a fidelity characteristic; and
performing video decoding for each pixel block of an encoded image corresponding to the master image, the video decoding comprising:
determining whether there is a mismatch between a fidelity characteristic of a reference pixel block and a fidelity characteristic of the fidelity region in which the pixel block is located,
if there is a mismatch, converting content of the reference pixel block to the fidelity domain of the pixel block, and
decode the pixel block using prediction data resulting from the converting content of the reference pixel block.

11. The method of claim 10, wherein the decoding further comprises:
if there is not a mismatch between the fidelity characteristic of the reference pixel block and the fidelity characteristic of the fidelity region in which the pixel block is located, decode the pixel block using the reference pixel block.

12. The method of claim 10, wherein the fidelity characteristic is pixel density

13. The method of claim 10, wherein the fidelity characteristic is color format.

14. The method of claim 10, wherein the fidelity characteristic is bit-depth.

15. The method of claim 10, wherein the fidelity characteristic is color gamut.

16. The method of claim 10, wherein the plurality of fidelity regions are defined according to an identified region-of-interest.

17. The method of claim 10, wherein the plurality of fidelity regions are defined according to screen content coding.

18. A computer-readable medium storing instruction that, when executed by a processor, effectuate operations comprising:
defining a plurality of fidelity regions within an image, each fidelity region associated with a fidelity characteristic; and
performing video encoding for each pixel block of the image, the video encoding comprising:
determining whether image data of a fidelity region neighboring the pixel block's fidelity region is a candidate for prediction,
if the image data of the neighboring fidelity region is determined to be a candidate for prediction, interpolating content of the neighboring fidelity region using the fidelity characteristic of the fidelity region in which the pixel block is located, and
predictively encoding the pixel block using the interpolated content.

19. A computing device comprising:
a processor;
a memory in mutual communication with the processor and storing instructions that, when executed by the processor, effectuate operations comprising:
defining a plurality of fidelity regions within an image, each fidelity region associated with a fidelity characteristic; and
performing video encoding for each pixel block of the image, the video encoding comprising:
determining whether image data of a fidelity region neighboring the pixel block's fidelity region is a candidate for prediction,
if the image data of the neighboring fidelity region is determined to be a candidate for prediction, interpolating content of the neighboring fidelity region using the fidelity characteristic of the fidelity region in which pixel block is located, and
predictively encoding the pixel block using the interpolated content.

20. A computer-readable medium storing instruction that, when executed by a processor, effectuate operations comprising:
receiving data defining a plurality of fidelity regions within a master image, each fidelity region associated with a fidelity characteristic; and
performing video decoding for each pixel block of an encoded image corresponding to the master image, the video decoding comprising:
determining whether there is a mismatch between a fidelity characteristic of a reference pixel block and a fidelity characteristic of the fidelity region in which the pixel block is located,
if there is a mismatch, converting content of the reference pixel block to the fidelity domain of the pixel block, and
decode the pixel block using prediction data resulting from the converting content of the reference pixel block.

21. A computing device comprising:
a processor;
a memory in mutual communication with the processor and storing instructions that, when executed by the processor, effectuate operations comprising:
receiving data defining a plurality of fidelity regions within a master image, each fidelity region associated with a fidelity characteristic; and
performing video decoding for each pixel block of an encoded image corresponding to the master image, the video decoding comprising:
determining whether there is a mismatch between a fidelity characteristic of a reference pixel block and a fidelity characteristic of the fidelity region in which the pixel block is located,
if there is a mismatch, converting content of the reference pixel block to the fidelity domain of the pixel block, and
decode the pixel block using prediction data resulting from the converting content of the reference pixel block.
